(19) United States
(12) Patent Application Publication
(10) Pub. No.: US 2015/0239199 A1
(43) Pub. Date: Aug. 27, 2015

(54) CORROSION PROTECTION PANELS FOR SHEET PILE WALLS

(71) Applicant: Michael K. Weber, Panama City, FL (US)

(72) Inventor: Michael K. Weber, Panama City, FL (US)

(21) Appl. No.: 14/629,804

(22) Filed: Feb. 24, 2015

Related U.S. Application Data
(60) Provisional application No. 61/944,096, filed on Feb. 25, 2014.

(51) Int. Cl. B32B 3/06; B32B 27/06; B32B 7/12; B32B 17/06; B32B 3/26; B32B 27/40

(52) U.S. Cl. CPC B32B 3/06; B32B 3/26; B32B 27/40; B32B 7/12; B32B 17/066; B32B 27/065; B32B 2250/02; B32B 2266/0278; B32B 2305/022; B32B 2307/752; B32B 2607/00

(57) ABSTRACT

A protective panel for use on a steel sheet piling wall can protect the wall from corrosion in a marine environment. The panel includes a layer of anti-corrosion gel, a layer of compressible foam that is impregnated with additional anti-corrosion gel, and layer of inert semi-rigid shell. Corrosion-resistant mechanical fasteners hold the panels in place against the steel sheet piling. If the sheet piling wall has significant corrosion, it should be cleaned prior to application of the protective panel.

### CROSS-REFERENCE TO RELATED APPLICATION

This application claims the benefit of U.S. Provisional Application No. 61/944,096, filed Feb. 25, 2014, the contents of which are incorporated herein by reference.

### FIELD OF INVENTION

The invention relates generally to protective panels for steel sheet piling, and more particularly to protective panels to prevent corrosion of steel sheet piling in marine environments.

### BACKGROUND OF THE INVENTION

Steel sheet piling systems are often used in marine environments such as at docks, ports, and other areas where it is necessary to hold back the soil or land to keep it from eroding into the sea. Sheet pile walls are used in areas where cargo ships are loaded and unloaded and similar areas. Steel sheet piles are long structural sections with a vertical interlocking system that create a continuous wall. The walls are most often used to retain the soil on one side and the water on the other.

Steel sheet piling will corrode in its natural marine environment due to the oxidation of steel by the saltwater and by freshwater. The steel can become pitted by the oxidation. Over time the thickness of the steel will diminish due to this natural corrosion. The loss of the steel will greatly reduce the strength and structural capacity of the wall if left untreated.

Thus, there is a need for an inexpensive, easily installed system for protecting steel sheet pile walls to prevent them from corroding in the marine environment.

### SUMMARY OF THE INVENTION

The invention provides various exemplary embodiments, including devices and systems that can be implemented as panels to protect steel sheet pile walls from corrosion.

These and other features and advantages of exemplary embodiments of the invention are described below with reference to the accompanying drawings.

### BRIEF DESCRIPTION OF THE DRAWINGS

FIG. 1 is an overhead cross-sectional view of the protective panel according to the present invention.

FIG. 2 is an overhead cross-sectional plan view of the protective panel as shown in FIG. 1.

FIG. 3 is an isometric partial cross-sectional view of a protective panel as shown in FIG. 1.

FIG. 4 is an elevation view of the protective panel connected to a sheet pile wall as in FIG. 1.

FIG. 5 is an overhead cross-sectional plan view of the protective panel as shown in FIG. 1.

### DETAILED DESCRIPTION

In the following description, a number of materials are identified as suitable for various facets of the implementations. These materials are to be treated as exemplary and are not intended to limit the scope of the claims. A number of dimensions and sizes are identified as suitable for various facets of the implementations. These dimensions and sizes are to be treated as exemplary and are not intended to limit the scope of the claims.

The invention is directed to corrosion protection panels that are installed on the face of a steel sheet piling wall to stop the corrosion of the steel and prevent further corrosion. The panels eliminate oxygen and water flow to the steel while an anti-corrosion gel inhibits corrosion. Such a gel may be a pretrolatum-based gel. The installation of these panels will eliminate costly repairs or even replacement of the sheet pile wall.

The corrosion protection panels according to the present invention include a number of different layers: a layer of anti-corrosive gel, foam impregnated with the gel, and an outer inert, semi-rigid protective shell. The gel may be a petroleum or petrolatum-based gel. The shell may be formed of fiberglass or vinyl material.

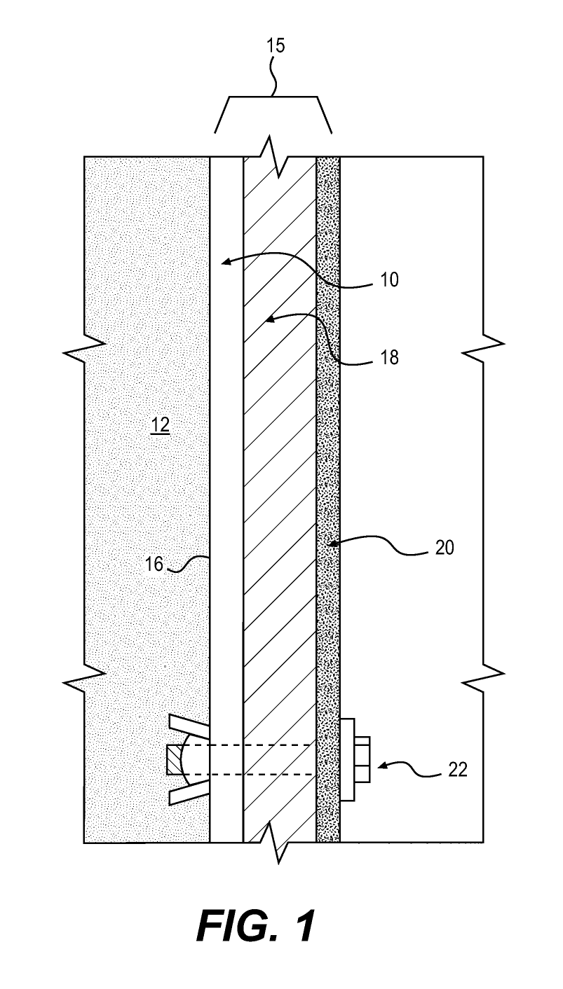

Referring to FIG. 1, an existing steel sheet metal piling 10 is shown holding back a soil backfill 12. A protective panel 15 according to the present invention is applied to the sheet metal piling 10 to protect against corrosion. If the existing sheet piling 10 is already corroded, the corroded steel sheet piles 10 must be cleaned to remove major corrosion, such as by use of high pressure water blasting or mechanical methods to remove the marine growth and existing corrosion. One such clean standard is SSPC-SP6/NACE 3 Commercial Blast Cleaning.

The protective panel 15 includes a layer of anti-corrosion gel 16 that is applied to the sheet metal piling 10. The anti-corrosion gel 16 is typically a petrolatum or petroleum jelly-based gel that is used to coat the metal piling 10. This gel 16 is used to fill in any gaps left by corrosion to the metal sheet piling 10 and to provide anti-corrosion properties to the panel 15. The layer of gel 16, such as a petroleum-based gel, may need to be applied to the steel before the panel 15 is installed depending on the depth of corrosion pits and/or indifferences in profile in the steel sheet piling 10. This additional layer of gel may also be applied to the face of the foam before installing the panel 15.

A compressible foam layer 18 is sandwiched between the steel sheet piling 10 and the protective shell 20 (described below). The compressible foam layer 18 (typically open cell polyurethane foam) is impregnated with additional anti-corrosion gel, such as a petroleum-based gel. This foam layer 18 will help to span the gaps due to driving tolerance differences within alignment of the steel sheet piling wall 10, corrosion pitting, and abnormalities in the wall 10 and will help protect the wall 10 when the steel is expanding and contracting. Different thicknesses of foam may be needed depending on the alignment and driving tolerance of the sheet pile wall, but a thickness of about 1 inch will be typical. The foam is adhered to the inside of the protective shell (described below) then the anti-corrosive gel is heated until the gel becomes more of a liquid consistency and can be poured onto the foam. Once the foam is fully saturated, the gel is allowed to cool and a plastic film is installed over the gel impregnated foam 18 to protect it while shipping and handling. The plastic film will be removed prior to installation.

The outer layer of defense is a protective shell 20 that is exposed to the marine environment and the elements of nature. This layer may include a variety of different materials, but is typically formed of an inert, semi-rigid material. For example, fiberglass or vinyl sheet piles may be used as the protective shell 20. The forms can be molded to fit the different styles and types of steel sheet piling 10 depending on the existing construction of the wall 10 to be protected. The owner or engineer may select different materials for the outer layer depending on the environment and/or budget of the project.

This panel 15 is bolted to the steel sheet pile wall 10 so that the foam layer 18 compresses and the anti-corrosive gel 16 fills all of the corrosion pits and imperfections in the sheet piling 10. With the panels 15 tightly bolted to the sheet pile wall 10, water and oxygen will no longer have contact with the steel sheet pile wall 10 and the corrosion process will be eliminated.

The entire panel 15 is bolted to the sheet piling wall 10 by use of corrosion-resistant mechanical fasteners 22. For example, blind bolts or threaded stud anchors may be used to bolt the panel 15 to the sheet piling wall 10. A mechanical fastener 22 is installed through the lap joints of the panels and through the steel sheet pile wall 10. The holes in the steel sheet pile can be drilled with a mag drill or similar method. These fasteners or anchors 22 are installed at about 12 to 18 inches on center. The anchors 22, whether blind bolts or threaded studs, have corrosion inhibiting properties. For example, they can include an anti-corrosion coating (such as galvanized) or be formed of stainless steel or other material that is resistant to corrosion in the marine environment. If blind bolts are used, a jig is set up and holes are drilled in the wall where the anchors 22 go. If shear studs are used, the same process is used except that the studs are welded to the wall by either friction welding or stick welding. A cap should be placed over the outer threads of the blind bolt or threaded stud anchor, which can be a high density plastic with a nut on the inside. This cap/nut will have the petroleum-based anti-corrosion gel inside of the cap as a corrosion inhibitor to protect the anchors.

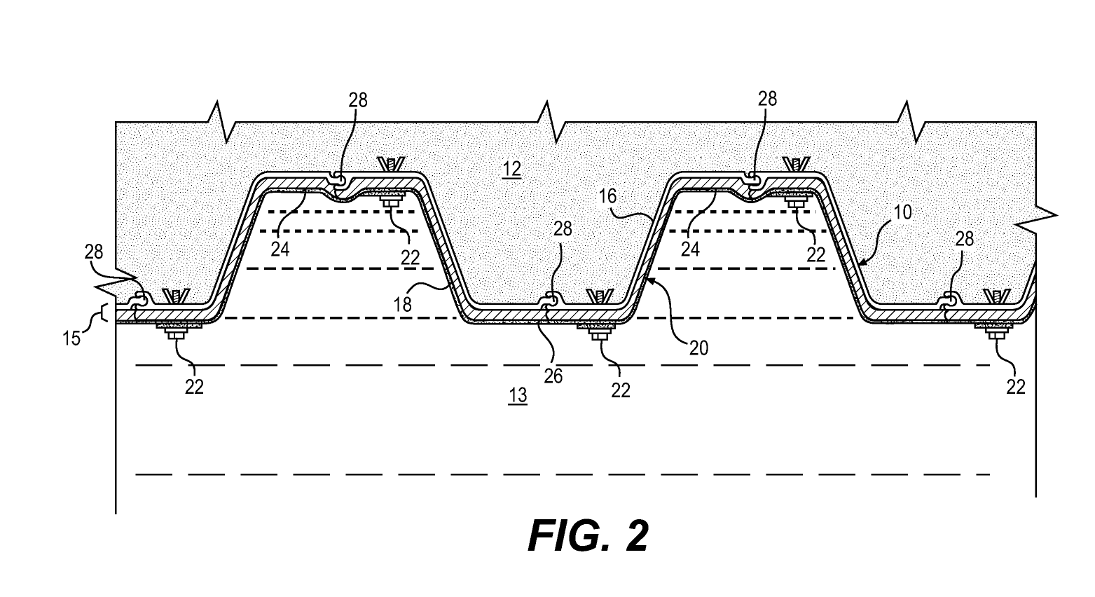

Referring to FIG. 2, the corrosion protection panels 15 are shown installed on the steel sheet pile wall 10. The sheet pile 10 is retaining soil 12 as shown as the land side behind the sheet pile 10 and the water side 13 is the side of the sheet pile that is subjected to environmental corrosion as the steel oxidizes and section thickness is reduced. The steel sheet piles 10 shown are a “Z” type sheet pile, based on its shape. The section of the sheet pile 10 that protrudes into the land 12 is called the “inpan” 24 and the section that protrudes towards the water 13 is called the “outpan” 26. The individual sheet piles 10 are connected to each other with an interlocking joint or “knuckle” 28 that is shown at the center of the inpans 24 and outpans 26. The corrosion protection panels 15 are shown bolted to the steel sheet piles 10 with the anti-corrosive gel impregnated foam 18 sandwiched in between the steel sheet pile 10 and the inert, semi-rigid outer molded shell 20 by a layer of anti-corrosion gel 16. The panels are attached with a “blind bolt” 22, similar to a drywall anchor, that expands on the backside of the sheet pile 10 when tightened on the face of the wall. These “blind bolt” anchors 22 are installed through the laps of the corrosion protection panels 15 and through predrilled holes in the steel sheet piles 10. There is one vertical row of bolts 22 located on the inpan 24 and one row on the outpan 26.

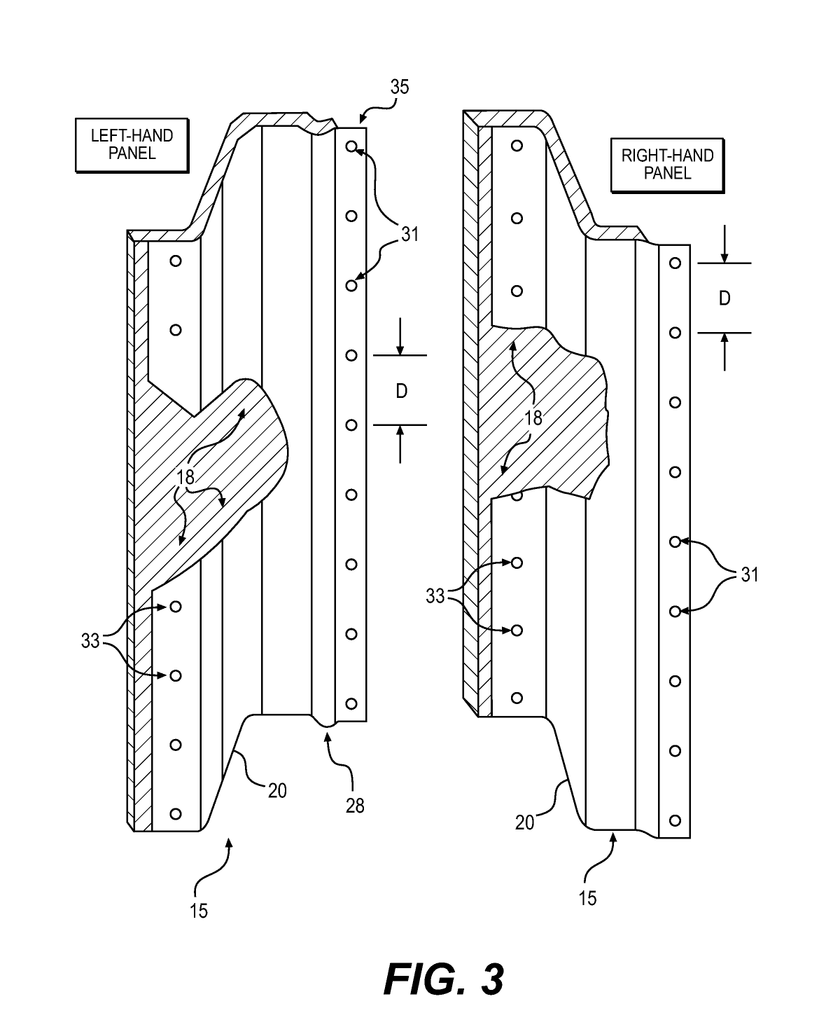

Referring to FIG. 3, “left-hand” and “right-hand” anti-corrosion protection panels 15 according to the present invention are shown. The “left-hand” or “right-hand” designations simply refer to the panel's orientation with respect to the inpan and outpan as described in FIG. 2 above. The inert semi-rigid panel 20 is molded to fit the contour of the specific sheet pile section that it will be protecting. The intert semi-rigid outer shell 20 may be formed of various thicknesses depending on the particular application. In a typical implementation, the outer shell 20 is about 3/16 inch thick. On the inpan 24 of the sheet pile, there is a bump out to fit the contour of the sheet pile knuckle 28 where the particular sheet piles attach to each other. The outer shell includes a corresponding bump out for the knuckle 28 if the sheet pile section requires it. The inert semi-rigid outer panel 18 is shown with the holes pre-drilled in the panels 20 for the “blind bolt” connectors. Some of the holes are standard sized holes 31, while others are oversized or slotted 33 to permit some adjustment of the panels 15 once mounted to the walls. These holes are shown in the lap joints 35 of the panels 20 to connect the panels 20 together. These holes will typically be spaced D about 12 to 18 inches apart, but other spacing is also permitted. On the back of the inert semi-rigid panel 20 the foam impregnated with anti-corrosive gel 18 is attached to the inert semi-rigid panel 20 with glue or other adhesive. There is a cut through the inert semi-rigid outer panel 20 to show where the foam 18 will be attached to the back of the inert semi-rigid panel 20. The foam 18 can be of various thicknesses. In a typical implementation, the foam 18 is about 1-inch thick.

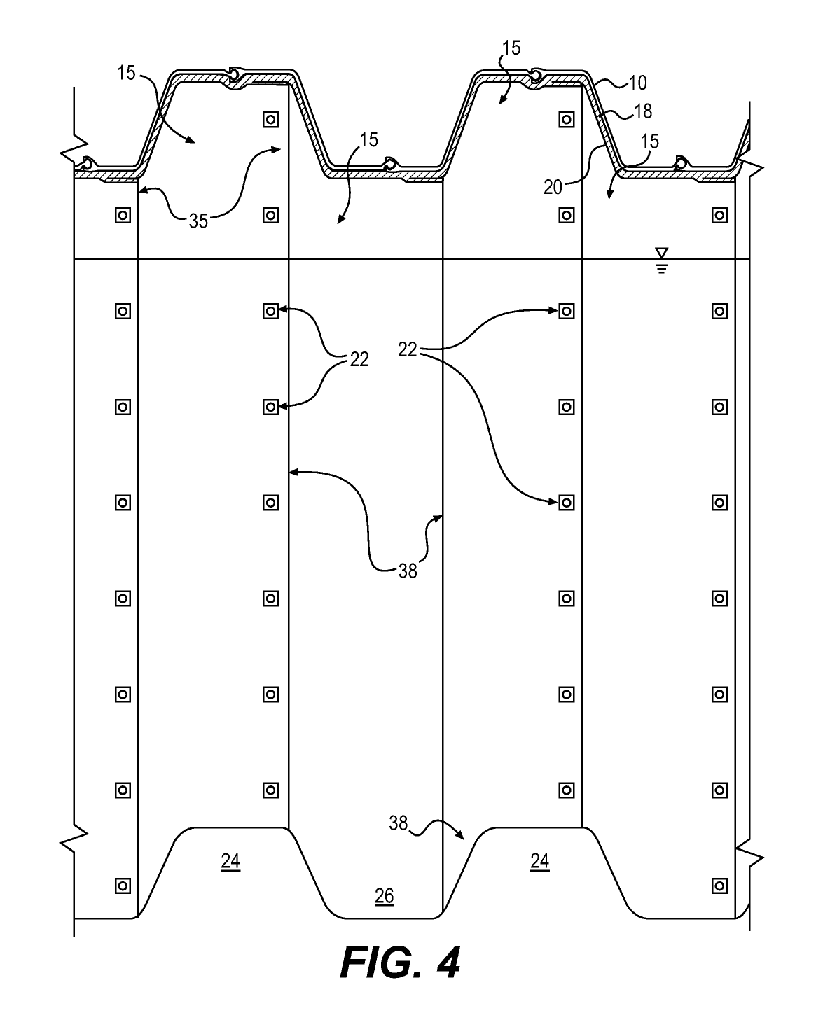

FIG. 4 shows the corrosion protection panels 15 connected to the steel sheet pile wall 10, including both left-hand and right-hand panels. The panels 15 include a layer of anti-corrosive gel impregnated foam 18 and an outer layer of inert semi-rigid panels 20 that are attached to the steel sheet panels 10. The mechanical fasteners 22 are shown at the lap joints 35, which have a square plate washer behind them. The mechanical fasteners 22 can also have an inert semi-rigid fiberglass or high density polyethylene (hdpe) head that snaps or screws on top of them with anti-corrosive gel inside to prevent the bolts 22 from corroding. The mechanical fasteners 22 should be either stainless steel, coated, or galvanized. The panels 15 extend from about 2 feet above the splash zone (area where waves hit the wall) to a minimum of about 8 feet below Mean Low Water (MLW). Depending on the corrosion environment, the panels 15 may extend to the mud line. If multiple panels 15 are to be installed vertically, then the panels 15 should be butted up to each other and a preformed inert semi-rigid strip would be screwed (such as with 316 Stainless Steel Self Tapping Screws) between the two panels 15 with the anti-corrosive gel inserted into any void to prevent corrosion. The lower panels 15 would be located at the panel joint 38 at the bottom of the upper panel shown in the drawing. Any number of panels 15 can be used. For example, if the wall is 24 feet tall, it might be desirable to use two 12-foot panels 15 instead of a single 24-foot panel 15.

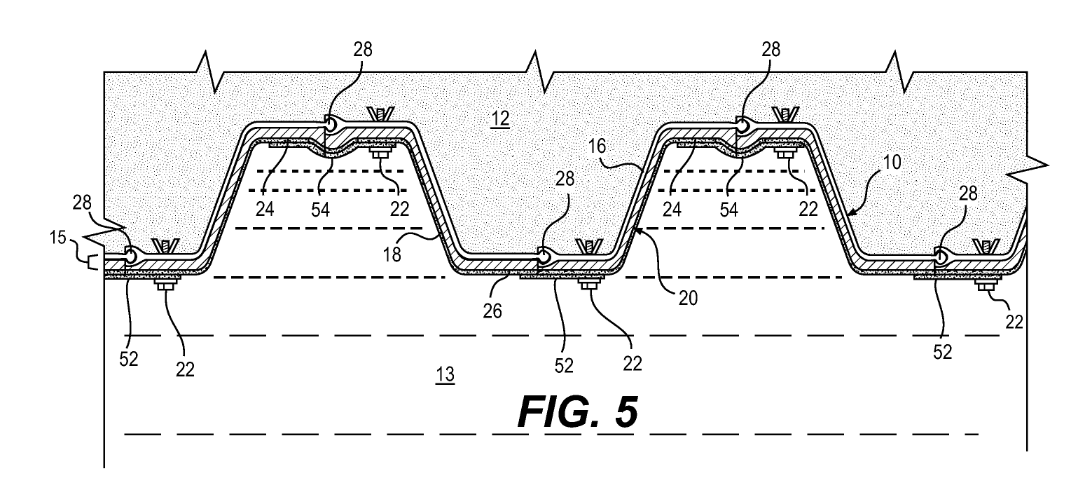

FIG. 5 is similar to FIG. 2. Corrosion protection panels 15 are shown installed on the steel sheet pile wall 10. In this implementation, there are no “right-hand” and “let-hand” panels. Instead, all of the panels 15 are of similar design. The joints or knuckles 28 are symmetrical, so as not to require a specific right-hand or left-hand implementation, thereby simplifying the design. A flat panel 52 and a U-shaped panel 54 are shown to further protect the outpan 26 and inpan 24 joints, respectively on the water side 13.

The protective panels described herein can be applied to existing steel sheet pile walls or to new steel sheet pile walls that have not yet been corroded. When added to an existing steel sheet pile wall, the corrosion must be cleaned from the steel sheet pile as described above.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. A panel to reduce or prevent corrosion of a steel sheet pile wall in a marine environment, comprising:
a foam layer impregnated with an anti-corrosion gel;
an inert semi-rigid protective shell attached to the foam layer; and
non-corroding mechanical fasteners to attach the panel to the steel sheet pile wall.

2. The panel of claim 1, wherein the steel sheet pile wall includes pits or abnormalities from corrosion and the panel further comprises a layer of anti-corrosion gel that fills in the pits or abnormalities in the steel sheet wall.

3. The panel of claim 1, wherein the foam layer comprises a compressible foam.

4. The panel of claim 3, wherein the foam layer comprises an open cell polyurethane foam.

5. The panel of claim 1, wherein the anti-corrosion gel is a gel that delays, stops, or seals corrosion of the steel sheet pile wall.

6. The panel of claim 1, wherein the anti-corrosion gel is formed of a petrolatum-based material.

7. The panel of claim 1, wherein the mechanical fasteners are formed of a corrosion resistant material or have been coated with a corrosion resistant material.

8. The panel of claim 1, wherein the mechanical fasteners are blind bolts or stud anchors.

9. The panel of claim 1, wherein the foam layer is attached to the inert semi-rigid protective shell by glue or other adhesive.

10. The panel of claim 1 shaped to substantially cover the steel sheet pile wall profile.

11. A protective panel for use on a steel sheet pile wall in a marine environment, comprising:
a compressible foam layer having an outer surface and being impregnated with anti-corrosion gel and including a layer of anti-corrosion gel on the outer surface thereof;
an inert semi-rigid shell attached to the foam layer impregnated with anti-corrosive gel; and
mechanical fasteners formed of or coated with a corrosion resistant material to attach the panel to the steel sheet pile wall.

12. The panel of claim 11, wherein the foam layer comprises an open cell polyurethane foam.

13. The panel of claim 11, wherein the anti-corrosion gel is formed of a petrolatum-based material.

14. The panel of claim 11, wherein the inert semi-rigid shell is formed of fiberglass or vinyl.

15. A protective panel for use on a steel sheet pile wall in a marine environment, comprising:
an open cell polyurethane foam layer having an outer surface and being impregnated with petrolatum-based anti-corrosion gel and including a layer of petrolatum-based anti-corrosion gel on the outer surface thereof;
a fiberglass or vinyl protective shell attached to the foam layer; and
blind bolts or stud anchors formed of or coated with a corrosion resistant material to attach the panel to the steel sheet pile wall.
